(19) United States
(12) Patent Application Publication
(10) Pub. No.: US 2025/0145827 A1
(43) Pub. Date: May 8, 2025

(54) METHODS FOR PREPARING ACRYLATED POLYVINYL ALCOHOL-POLYESTER GRAFT COPOLYMERS

(71) Applicant: Xerox Corporation, Norwalk, CT (US)

(72) Inventors: Naveen CHOPRA, Oakville (CA); Mihaela Maria BIRAU, Hamilton (CA); Aleksa DOVIJARSKI, Etobicoke (CA); Gregory MCGUIRE, Oakville (CA)

(73) Assignee: Xerox Corporation, Norwalk, CT (US)

(21) Appl. No.: 18/502,772

(22) Filed: Nov. 6, 2023

(51) Int. Cl. C08L 87/00; B01J 23/14; C08J 3/24; C08J 3/28

(52) U.S. Cl. CPC C08L 87/005; B01J 23/14; C08J 3/24; C08J 3/28; C08L 2312/06

(57) ABSTRACT

Methods for preparing acrylated polyvinyl alcohol (PVA)-polyester graft copolymers may comprise: forming a PVA-polyester graft copolymer in a solvent; and without isolating the PVA-polyester graft copolymer or separating the PVA-polyester graft copolymer from the solvent, reacting the PVA-polyester graft copolymer with an acrylating agent, optionally in the presence of a base, to form an acrylated PVA-polyester graft copolymer.

### FIELD

The present disclosure relates to preparation of acrylated polyvinyl alcohol-polyester graft copolymers and, more particularly, to syntheses of acrylated polyvinyl alcohol-polyester graft copolymers by in situ acrylation.

### BACKGROUND

Acrylated graft copolymers are a class of modified polymers in which acrylate monomers are bonded to a pre-existing polymer backbone. The resulting acrylated graft copolymers possess properties that may not be present in the parent polymer, thereby facilitating their use in various applications. Acrylate polymers, including acrylated graft copolymers, have gained substantial attention in industries such as coatings, adhesives, and paints due to their excellent adhesion properties and controlled flexibility. In some cases, the acrylate groups may be cured under suitable conditions to form a crosslinked polymer network. The crosslinked polymer network often forms polymer gels that may be utilized in numerous applications.

Acrylated polyvinyl alcohol-polyester graft copolymers represent a specialized class of acrylated graft copolymers. A key advantage of acrylated polyvinyl alcohol-polyester graft copolymers is that they may be compostable, thereby reducing landfill burden when objects containing this polymer are discarded. Acrylated polyvinyl alcohol-polyester graft copolymers, once crosslinked, may be particularly useful for forming gel polymer electrolytes for batteries, such as those described in U.S. Patent Application Publications 2022/0173433 and 2022/0344713.

Acrylated polyvinyl alcohol-polyester graft copolymers are conventionally synthesized in a two-step process. The initial step entails grafting of a polyester component onto a portion of the hydroxyl groups of polyvinyl alcohol, followed by isolation of the resulting polyvinyl alcohol-polyester graft copolymer (intermediate copolymer). The intermediate copolymer is then reacted with an acrylate-containing reagent (acrylating agent) to introduce a plurality of acrylate groups onto hydroxyl groups of the intermediate copolymer. Following each step in the conventional two-step process, the reaction products are normally isolated from the reaction solvent, followed by washing and centrifugation multiple times to remove reagents and side products. This approach causes the overall process to be time-consuming and laborious and may result in product losses. Product losses may be especially prevalent, as the intermediate copolymer tends to be very sticky and is not easily isolated or manipulated. Excessive acrylation and occurrence of side reactions, including polymerization of the acrylate-containing reagent or premature polymerization of the acrylated polyvinyl alcohol-polyester graft copolymer, may also be problematic in some instances.

### SUMMARY

According to embodiments consistent with the present disclosure, methods may comprise: forming a polyvinyl alcohol (PVA)-polyester graft copolymer in a solvent; and without isolating the PVA-polyester graft copolymer or separating the PVA-polyester graft copolymer from the solvent, reacting the PVA-polyester graft copolymer with an acrylating agent, optionally in the presence of a base, to form an acrylated PVA-polyester graft copolymer.

In some or other embodiments, methods of the present disclosure may comprise: reacting polyvinyl alcohol (PVA) with ε-caprolactone in a reaction mixture comprising an aprotic solvent and a catalyst effective to promote ring-opening polymerization of the ε-caprolactone, thereby forming a PVA-polycaprolactone (PCL) graft copolymer; without isolating the PVA-PCL graft copolymer or separating the PVA-PCL graft copolymer from the aprotic solvent, reacting the PVA-PCL graft copolymer with acryloyl chloride in the presence of a tertiary amine to form an acrylated PVA-PCL graft copolymer; and isolating the acrylated PVA-PCL graft copolymer from the aprotic solvent. The catalyst comprises a tin (II) carboxylate.

### BRIEF DESCRIPTION OF THE DRAWINGS

Not applicable.

### DETAILED DESCRIPTION

The present disclosure relates to preparation of acrylated polyvinyl alcohol-polyester graft copolymers and, more particularly, to syntheses of acrylated polyvinyl alcohol-polyester graft copolymers by in situ acrylation.

As discussed above, there are difficulties associated with conventional syntheses of acrylated polyvinyl alcohol-polyester graft copolymers. At the least, the properties of these materials lead to difficult handling and yield loss during their synthesis. In addition, excessive acrylation and side reactions may also be problematic. As such, there exists a significant need for alternative synthetic methods for preparing these types of polymers in a more efficient and reliable manner, while still maintaining high-quality polymer product.

The present disclosure addresses the foregoing challenges of synthesizing acrylated polyvinyl alcohol-polyester graft copolymers by performing ring-opening polymerization and acrylate grafting without isolating the intermediate copolymer (polyvinyl alcohol-polyester graft copolymer) or separating the intermediate copolymer from the solvent in which the ring-opening polymerization is performed. Such processes may take place in a single reaction vessel (i.e., so-called one-pot syntheses), but may alternately take place in a series of reaction vessels, again without isolation or separation of the intermediate copolymer taking place. In illustrative examples, the acrylated polyvinyl alcohol-polyester graft copolymer may comprise an acrylated polyvinyl alcohol (PVA)-caprolactone (PCL) graft copolymer. By altering the conventional two-step synthesis procedure to forego isolation of the intermediate copolymer between the two reaction steps, the handling, yield, and throughput of the acrylated polyvinyl alcohol polyester graft copolymer may be improved without significantly altering product quality. More reproducible polymerization performance may be realized in some cases.

Methods for preparing acrylated polyvinyl alcohol-polyester graft copolymers according to the present disclosure may comprise: forming a polyvinyl alcohol (PVA)-polyester graft copolymer in a solvent (e.g., by ring-opening polymerization); and without isolating the PVA-polyester graft copolymer or separating the PVA-polyester graft copolymer from the solvent, reacting the PVA-polyester graft copolymer with an acrylating agent, optionally in the presence of a base, to form an acrylated PVA-polyester graft copolymer. The methods may further comprise isolating the acrylated PVA-polyester graft copolymer from the solvent, such as through precipitation. In some examples, forming the PVA-polyester graft copolymer may comprise: reacting PVA with a cyclic ester in a reaction mixture comprising the solvent and a catalyst effective to promote ring-opening polymerization of the cyclic ester to thereby form the PVA-polyester graft copolymer, which may then be reacted in situ with the acrylating agent to form the acrylated PVA-polyester graft copolymer. In more specific examples, the acrylated polyvinyl alcohol-polyester graft copolymer may be formed by copolymerizing PVA with ε-caprolactone, thereby forming an acrylated polyvinyl alcohol (PVA)-polycaprolactone (PCL) graft copolymer.

In the disclosure herein, the acrylating agent may comprise acryloyl chloride. Acryloyl chloride may be advantageous in terms of cost and the ease with which it undergoes a reaction with hydroxyl groups of the PVA-polyester graft copolymer to attach a plurality of acrylate groups by ester linkages. Other suitable acrylating agents may include acrylic anhydride or even acrylic acid itself. Acrylic acid, for example, may introduce the acrylate groups in the presence of an acid catalyst (e.g., via Fischer esterification). It is to be appreciated that substituted acrylating agents (e.g., the corresponding methacrylate analogues, for instance) may similarly be used in any of the methods disclosed herein.

In the disclosure herein, the cyclic ester, also referred to as a lactone, forming the polyester component of the PVA-polyester graft copolymer may comprise any cyclic ester capable of undergoing ring-opening polymerization in the presence of a suitable catalyst to promote grafting of a polyester onto PVA. Non-limiting examples of suitable cyclic esters may include, but are not limited to, α-acetolactone, β-propiolactone, γ-butyrolactone, δ-valerolactone, ε-caprolactone, ε-decalactone, L-lactide, D-lactide, L-glycolide, D-glycolide, the like, and any combination thereof. In some examples, the cyclic ester used in the methods of the present disclosure may comprise or consist of F-caprolactone, which may be referred to herein simply as caprolactone (CL). When the cyclic ester comprises or consists of F-caprolactone, the acrylated PVA-polyester graft copolymer formed by the methods of the present disclosure may comprise an acrylated PVA-polycaprolactone (PCL) graft copolymer.

Polyvinyl alcohol is generally obtained by partial hydrolysis of polyvinyl acetate. Any polyvinyl alcohol may be utilized in the methods of the present disclosure, provided that sufficient free hydroxyl groups are present for grafting of the polyester thereto. In non-limiting examples, the degree of hydrolysis of the polyvinyl alcohol may be about 30% or above, or about 40% or above, or about 50% or above, or about 60% or above, or about 70% or above, or about 80% or above, or about 90% or above, such as about 30% to about 80% or about 45% to about 75%. The degree of hydrolysis refers to the percentage of acetate groups that are hydrolyzed from polyvinyl acetate to afford the resulting polyvinyl alcohol. It is to be recognized that at least some residual acetate groups may remain in a given polyvinyl alcohol, although some polyvinyl alcohols may have essentially 100% hydrolysis. The molecular weight of the polyvinyl alcohol (before polyester grafting and acrylation) may range from about 1 kDa to about 1000 kDa, or about 10 kDa to about 100 kDa, or about 5 kDa to about 50 kDa.

Catalysts effective to promote ring-opening polymerization of the cyclic ester may comprise a transition metal complex, such as a tin (II) complex, preferably a tin (II) carboxylate. In non-limiting examples, the catalyst may comprise tin (II) 2-ethylhexanoate, also referred to as tin (II) octoate or stannous octoate [Sn(oct)₂]. Other examples of suitable catalysts comprising a transition metal and suitable for promoting ring-opening polymerization will be familiar to one having ordinary skill in the art.

The solvent used in the methods of the present disclosure may comprise any aprotic solvent capable of dissolving PVA and the cyclic ester, such as ε-caprolactone. Examples of suitable aprotic solvents may include, but are not limited to, acetone, acetonitrile, dichloromethane, dimethylformamide, dimethylpropyleneurea, dimethyl sulfoxide, ethyl acetate, hexamethylphosphoramide, N-methyl-2-pyrrolidone, pyridine, sulfolane, tetrahydofuran, the like, and any combination thereof. In particular examples, the solvent may comprise, N-methylpyrrolidone, dimethylformamide, or any combination thereof. Because the methods of the present disclosure are conducted without isolating the PVA-polyester graft copolymer, the same solvent may be utilized for both the copolymerization step and the acrylation step. As such, the solvent is selected to afford compatibility with both steps.

The concentration of PVA in the solvent during the copolymerization step to produce the PVA-polyester graft copolymer may be, for example, about 10 wt % to about 40 wt %, or about 10 wt % to about 30 wt %, or about 10 wt % to about 20 wt %, or about 20 wt % to about 40 wt %, or about 20 wt % to about 30 wt %, or about 30 wt % to about 40 wt %. Similarly, the concentration of the cyclic ester in the copolymerization step to produce the PVA-polyester graft copolymer may be, for example, about 10 wt % to about 40 wt %, or about 10 wt % to about 30 wt %, or about 10 wt % to about 20 wt %, or about 20 wt % to about 40 wt %, or about 20 wt % to about 30 wt %, or about 30 wt % to about 40 wt %. The catalyst concentration in the copolymerization step to produce the PVA-polyester graft copolymer may be, for example, about 0.01 wt % to about 1 wt %, or about 0.01 wt % to about 0.5 wt %, or about 0.01 wt % to about 0.1 wt %, or about 0.1 wt % to about 1 wt %, or about 0.1 wt % to about 0.5 wt %, or about 0.5 wt % to about 1 wt %.

To promote ring-opening polymerization of the cyclic ester for grafting a polyester onto the PVA, the reaction mixture may be heated while forming the PVA-polyester graft copolymer. In non-limiting examples, the reaction mixture may be heated at about 80° C. to about 120° C., or about 80° C. to about 100° C., or about 100° C. to about 120° C. In some or other examples, the reaction mixture may be heated at the desired temperature for a time of about 1 hour to about 48 hours, or about 1 hour to about 36 hours, or about 1 hour to about 24 hours, or about 24 hours to about 48 hours, or about 24 hours to about 36 hours, or about 36 hours to about 48 hours.

Under the suitable conditions specified above, the PVA may react with the cyclic ester in the presence of the catalyst to form a PVA-polyester graft copolymer as an intermediate copolymer. Without isolating the PVA-polyester graft copolymer or separating the PVA-polyester graft copolymer from the solvent, the PVA-polyester graft copolymer may then be contacted with an acrylating agent, such as acryloyl chloride, and reacted therewith, optionally in the presence of a base, to form an acrylated PVA-polyester graft copolymer, such as an acrylated PVA-PCL graft copolymer.

Preferably, acrylation of the PVA-PCL graft copolymer is conducted in the presence of the base, especially when the acrylating agent comprises acryloyl chloride. The base may trap hydrogen chloride released upon reacting the acryloyl chloride with hydroxyl group(s) of the PVA-PCL graft copolymer. Suitable bases may include amine bases that are insufficiently nucleophilic to react with the acryloyl chloride. In non-limiting examples, suitable amine bases may include trimethylamine, triethylamine, N,N-diisopropylethylamine (Hunig's base), or any combination thereof, preferably triethylamine.

Acrylation of the PVA-polyester graft copolymer with the acrylating agent may occur with heating taking place. In non-limiting examples, heating may occur at about 60° C. to about 100° C., or about 60° C. to about 80° C., or about 80° C. to about 100° C. In some or other examples, heating may take place at the desired temperature for a time ranging from about 1 hour to about 12 hours, or about 1 hour to about 6 hours, or about 1 hour to about 4 hours, or about 4 hours to about 12 hours, or about 4 hours to about 6 hours, or about 6 hours to about 12 hours.

Following acrylation of the PVA-polyester graft copolymer, the acrylated PVA-polyester graft copolymer may be isolated from the solvent. In non-limiting examples, the acrylated PVA-polyester graft copolymer may be isolated by precipitation with an alcohol. For example, isopropyl alcohol may be introduced after acrylation takes place to form a precipitate comprising the acrylated PVA-polyester graft copolymer. Other alcohols may also be used similarly. The acrylated PVA-polyester graft copolymer may then be isolated by centrifugation, filtration, decantation, or similar techniques. Additional washing of the acrylated PVA-polyester graft copolymer with a solvent in which the acrylated PVA-polyester graft copolymer is insoluble, such as an alcohol, may be further conducted during isolation.

The acrylated PVA-polyester graft copolymer may, for example, have a molar ratio of PVA to polyester of about 1:10 to about 40:1, or about 1:10 to about 25:1, or about 1:10 to about 15:1, or about 1:10 to about 10:1, or about 1:10 to about 5:1, or about 1:10 to about 1:1, or about 1:1 to about 40:1, or about 1:1 to about 25:1, or about 1:1 to about 15:1, or about 1:1 to about 10:1, or about 1:1 to about 5:1, or about 5:1 to about 40:1, or about 5:1 to about 25:1, or about 5:1 to about 15:1. Additionally, the acrylated PVA-polyester graft copolymer may, for example, have a polyester degree of polymerization of about 2 to about 15, or about 2 to about 5, or about 4 to about 6, or about 4 to about 8, or about 5 to about 15, or about 5 to about 10, or about 10 to about 15. The polyester degree of polymerization refers to the average number of cyclic ester monomer units (after ring opening) that become incorporated in the grafted polyester at each residual hydroxyl group undergoing grafting.

Accordingly, example reactions and conditions thereof leading to production of an acrylated PVA-PCL graft copolymer are shown below.

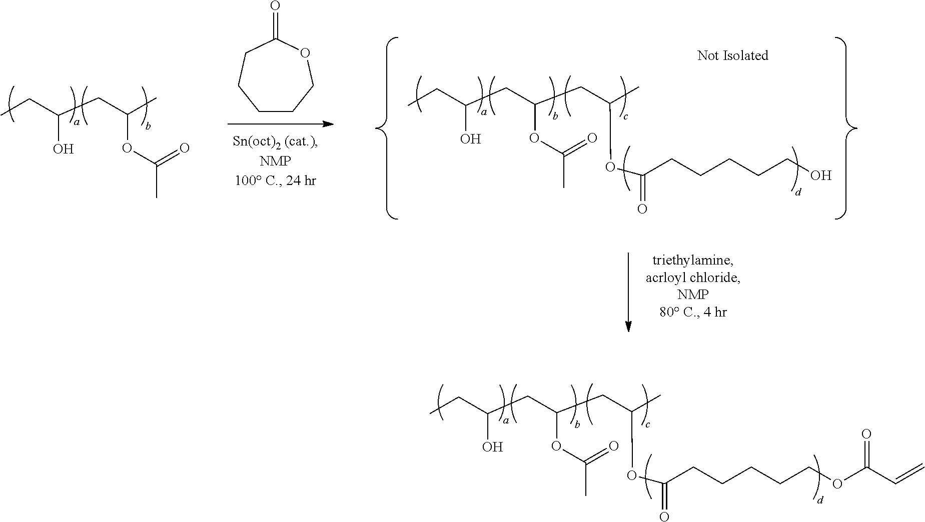

As shown, PVA may be reacted with ε-caprolactone in a solvent, preferably an aprotic solvent, in the presence of a suitable catalyst, in this case a tin (II) catalyst, under heating to form PVA-PCL graft copolymer. The PVA-PCL graft copolymer is formed by attaching ring-opened ε-caprolactone onto a free hydroxyl group of PVA, followed by ring-opening polymerization of additional ε-caprolactone onto the resultant primary hydroxyl group of the initially grafted ε-caprolactone monomer. Without isolating the PVA-PCL graft copolymer or separating the PVA-PCL graft copolymer from the solvent, the PVA-PCL graft copolymer may be subsequently reacted with acryloyl chloride in the presence of a tertiary amine base to introduce an acrylate group via an ester bond upon the terminal primary hydroxyl group of the grafted polyester, thereby forming an acrylated PVA-PCL graft copolymer. Although not shown, some of the secondary hydroxyl groups (arising from PVA) that do not participate in forming the grafted polyester may undergo a similar reaction with acryloyl chloride to introduce additional acrylate groups directly onto the backbone of the polymer chain. Because the primary hydroxyl group upon the grafted polyester tends to be more reactive by virtue of its lower steric hindrance, the primary hydroxyl group may react in preference to the secondary hydroxyl groups, though not necessarily exclusively. Following the depicted reactions, the acrylated PVA-PCL graft copolymer may be isolated from the solvent. In the above structures, at least a, c, and d are non-zero integers, wherein the sum of a-d places the molecular weight of the acrylated PVA-PCL graft copolymer in a desired range. It is to be appreciated that the locations at which the PCL is introduced to the PVA, the locations at which residual acetate groups remain on the PVA, and the locations at which residual backbone hydroxyl groups remain on the PVA are random in nature, and the depicted PVA-PCL graft copolymer and/or acrylated PVA/PCL graft copolymer should not be construed as having the depicted repeat unit or any other particular repeat unit.

Accordingly, in more specific examples, methods of the present disclosure may comprise: reacting polyvinyl alcohol (PVA) with ε-caprolactone in a reaction mixture comprsing an aprotic solvent and a catalyst effective to promote ring-opening polymerization of the ε-caprolactone, thereby forming a PVA-polycaprolactone (PCL) graft copolymer; wherein the catalyst comprises a tin (II) carboxylate; without isolating the PVA-PCL graft copolymer or separating the PVA-PCL graft copolymer from the aprotic solvent, reacting the PVA-PCL graft copolymer with acryloyl chloride in the presence of a tertiary amine to form an acrylated PVA-PCL graft copolymer; and isolating the acrylated PVA-PCL graft copolymer from the aprotic solvent.

After isolation of the acrylated PVA-polyester graft copolymer, the acrylated PVA-polyester graft copolymer may undergo curing to promote crosslinking polymerization of the acrylate groups. In some examples, the resulting crosslinked acrylated PVA-polyester graft copolymer may form a gel polymer.

Furthermore, the isolated acrylated PVA-polyester graft may be used in the preparation of a gel polymer electrolyte. In any embodiment, after isolating the acrylated PVA-polyester graft copolymer, the acrylated PVA-polyester graft copolymer may be combined with an electrolyte solution to form a gel polymer electrolyte. The electrolyte solution may comprise at least one salt, for example, an electrolyte solution including zinc chloride, ammonium chloride, or any combination thereof. The acrylated PVA-polyester graft copolymer may be then be irradiated with a source of electromagnetic radiation suitable to polymerize acrylate groups and in the presence of a photoinitiator. Upon exposure to a suitable source of electromagnetic radiation, such as UV radiation, curing of the gel polymer electrolyte may take place upon crosslinking the acrylate groups. Additional details regarding suitable photopolymerization processes and photoinitiators will be familiar to one having ordinary skill in the art.

Embodiments disclosed herein include:

A. Methods for preparing acrylated polyvinyl alcohol-polyester graft copolymers. The methods comprise: forming a polyvinyl alcohol (PVA)-polyester graft copolymer in a solvent; and without isolating the PVA-polyester graft copolymer or separating the PVA-polyester graft copolymer from the solvent, reacting the PVA-polyester graft copolymer with an acrylating agent, optionally in the presence of a base, to form an acrylated PVA-polyester graft copolymer.

B. Methods for preparing acrylated polyvinyl alcohol-polycaprolactone graft copolymers. The methods comprise: reacting polyvinyl alcohol (PVA) with ε-caprolactone in a reaction mixture comprising an aprotic solvent and a catalyst effective to promote ring-opening polymerization of the ε-caprolactone, thereby forming a PVA-polycaprolactone (PCL) graft copolymer; wherein the catalyst comprises a tin (II) carboxylate; without isolating the PVA-PCL graft copolymer or separating the PVA-PCL graft copolymer from the aprotic solvent, reacting the PVA-PCL graft copolymer with acryloyl chloride in the presence of a tertiary amine to form an acrylated PVA-PCL graft copolymer; and isolating the acrylated PVA-PCL graft copolymer from the aprotic solvent.

Each of embodiments A and B have one or more of the following additional elements in any combination:

Element 1: wherein the method further comprises: isolating the acrylated PVA-polyester graft copolymer from the solvent.

Element 2: wherein the solvent comprises an aprotic solvent.

Element 3: wherein the solvent comprises N-methyl-2-pyrrolidone, dimethylformamide, or any combination thereof.

Element 4: wherein forming the PVA-polyester graft copolymer comprises: reacting PVA with a cyclic ester in a reaction mixture comprising the solvent and a catalyst effect to promote ring-opening polymerization of the cyclic ester to form the PVA-polyester graft copolymer.

Element 5: wherein the cyclic ester comprises F-caprolactone.

Element 6: wherein the catalyst is a tin (II) catalyst.

Element 7: wherein the catalyst comprises a tin (II) carboxylate.

Element 8: wherein the base is present and comprises a tertiary amine.

Element 9: wherein the reaction mixture is heated while forming the PVA-polyester graft copolymer.

Element 10: wherein the reaction mixture is heated at about 80° C. to about 120° C. while forming the PVA-polyester graft copolymer.

Element 11: wherein heating takes place while forming the acrylated PVA-polyester graft copolymer.

Element 12: wherein the heating occurs at about 60° C. to about 100° C. while forming the acrylated PVA-polyester graft copolymer

Element 13: wherein the acrylating agent comprises acryloyl chloride.

Element 14: wherein the acrylated PVA-polyester graft copolymer has a molar ratio of PVA to polyester of about 1:10 to about 25:1.

Element 15: wherein the acrylated PVA-polyester graft copolymer has a polyester degree of polymerization of about 2 to about 15.

Element 16: wherein the method further comprises: isolating the acrylated PVA-polyester graft copolymer from the solvent; after isolating the acrylated PVA-polyester graft copolymer, combining the acrylated PVA-polyester graft copolymer with an electrolyte solution to form a gel polymer electrolyte; and irradiating the acrylated PVA-polyester graft copolymer with a source of electromagnetic radiation suitable to photopolymerize acrylate groups and in the presence of a photoinitiator to cure the gel polymer electrolyte by crosslinking the acrylated PVA-polyester graft copolymer.

Element 17: wherein the acrylate PVA-PCL graft copolymer is isolated from the aprotic solvent by precipitation with an alcohol.

By way of non-limiting example, exemplary combinations applicable to A and B include, but are not limited to: 1 and 2; 1 and 3; 1 and 4; 1 and 5; 1 and 8; 1 and 11; 1, 11, and 12; 1 and 13; 1 and 14; 1 and 15; 1 and 16; 2 and 3; 2 and 4; 2 and 11; 2, 11, and 12; 2 and 13; 2 and 14; 2 and 15; 2 and 16; 3 and 4; 3 and 11; 3, 11, and 12; 3 and 13; 3 and 14; 3 and 15; 3 and 16; 4 and 5; 4-6; 4 and 6; 4 and 7; 4 and 8; 4 and 9; 4 and 10; 4 and 11; 4, 11, and 12; 4 and 13; 4 and 14; 4 and 15; 4 and 16; 5 and 6; 5 and 7; 5 and 8; 5 and 10; 5 and 11; 5 and 13; 5 and 15; 5 and 16; 8 and 9; 8 and 11; 8, 11, and 12; 8 and 13; 8 and 14; 8 and 15; 8 and 16; 11 and 12; 11 and 13; 11 and 14; 11 and 15; 11 and 16; 12 and 13; 12 and 14; 12 and 15; 12 and 16; 13 and 14; 13 and 15; 13 and 16; 14 and 15; 14 and 16; 15 and 16; 1-3; 1-4; 4-6; 4-6 and 9; 4-6, 9, and 10; 4-9; 4-10; 4-9 and 11; and 1-4 and 13-15.

The present disclosure is further directed to the following non-limiting clauses:
Clause 1. A method comprising:
   forming a polyvinyl alcohol (PVA)-polyester graft copolymer in a solvent; and
   without isolating the PVA-polyester graft copolymer or separating the PVA-polyester graft copolymer from the solvent, reacting the PVA-polyester graft copolymer with an acrylating agent, optionally in the presence of a base, to form an acrylated PVA-polyester graft copolymer.
Clause 2. The method of clause 1, further comprising: isolating the acrylated PVA-polyester graft copolymer from the solvent.
Clause 3. The method of clause 1 or clause 2, wherein the solvent comprises an aprotic solvent.
Clause 4. The method of any one of clauses 1-3, wherein the solvent comprises N-methyl-2-pyrrolidone, dimethylformamide, or any combination thereof.
Clause 5. The method of any one of clauses 1-4, wherein forming the PVA-polyester graft copolymer comprises:
   reacting PVA with a cyclic ester in a reaction mixture comprising the solvent and a catalyst effective to promote ring-opening polymerization of the cyclic ester to form the PVA-polyester graft copolymer.
Clause 6. The method of clause 5, wherein the cyclic ester comprises F-caprolactone.
Clause 7. The method of clause 5 or clause 6, wherein the catalyst comprises a tin (II) catalyst.
Clause 8. The method of any one of clauses 5-7, wherein the catalyst comprises a tin (II) carboxylate.
Clause 9. The method of any one of clauses 5-8, wherein the reaction mixture is heated while forming the PVA-polyester graft copolymer.
Clause 10. The method of clause 9, wherein the reaction mixture is heated at about 80° C. to about 120° C. while forming the PVA-polyester graft copolymer.
Clause 11. The method of any one of clauses 1-10, wherein heating takes place while forming the acrylated PVA-polyester graft copolymer.
Clause 12. The method of clause 11, wherein the heating occurs at about 60° C. to about 100° C. while forming the acrylated PVA-polyester graft copolymer.
Clause 13. The method of any one of clauses 1-12, wherein the base is present and comprises a tertiary amine.
Clause 14. The method of any one of clauses 1-13, wherein the acrylating agent comprises acryloyl chloride.
Clause 15. The method of any one of clauses 1-14, wherein the acrylated PVA-polyester graft copolymer has a molar ratio of PVA to polyester of about 1:10 to about 25:1.
Clause 16. The method of any one of clauses 1-15, wherein the acrylated PVA-polyester graft copolymer has a polyester degree of polymerization of about 2 to about 15.
Clause 17. The method of any one of clauses 1-16, further comprising:
   isolating the acrylated PVA-polyester graft copolymer from the solvent;
   after isolating the acrylated PVA-polyester graft copolymer, combining the acrylated PVA-polyester graft copolymer with an electrolyte solution to form a gel polymer electrolyte; and
   irradiating the acrylated PVA-polyester graft copolymer with a source of electromagnetic radiation suitable to photopolymerize acrylate groups and in the presence of a photoinitiator to cure the gel polymer electrolyte by crosslinking the acrylated PVA-polyester graft copolymer.
Clause 18. A method comprising:
   reacting polyvinyl alcohol (PVA) with F-caprolactone in a reaction mixture comprising an aprotic solvent and a catalyst effective to promote ring-opening polymerization of the F-caprolactone, thereby forming a PVA-polycaprolactone (PCL) graft copolymer;
      wherein the catalyst comprises a tin (II) carboxylate;
   without isolating the PVA-PCL graft copolymer or separating the PVA-PCL graft copolymer from the aprotic solvent, reacting the PVA-PCL graft copolymer with acryloyl chloride in the presence of a tertiary amine to form an acrylated PVA-PCL graft copolymer; and
   isolating the acrylated PVA-PCL graft copolymer from the aprotic solvent.
Clause 19. The method of clause 18, wherein the aprotic solvent comprises N-methyl-2-pyrrolidone, dimethylformamide, or any combination thereof.
Clause 20. The method of clause 18 or clause 19, wherein the acrylated PVA-PCL graft copolymer is isolated from the aprotic solvent by precipitation with an alcohol.

To facilitate a better understanding of the embodiments of the present disclosure, the following examples of preferred or representative embodiments are given. In no way should the following examples be read to limit, or to define, the scope of the disclosure.

### Examples

Two-pot synthesis of an acrylated PVA-PCL graft copolymer (representative comparative sample). 10.0 g of PVA (MW=10 kDa, 74% hydrolyzed, 227 mmol) was heated at 100° C. and stirred for 30 minutes in vacuo to dry the PVA. After drying, the PVA was cooled to 60° C., and 80 mL of dry distilled dimethyl sulfoxide (DMSO) was added to dissolve the PVA. Subsequently, 160 μL of tin (II) 2-ethylhexanoate catalyst was added to the PVA-DMSO solution, and the mixture was stirred for 30 minutes at 60° C. After stirring the mixture under heating, 25.1 mL of distilled ε-caprolactone (227 mmol) was added. The reaction mixture was heated at 100° C. and stirred overnight. Thereafter, the reaction mixture was cooled to room temperature, and the reaction contents were mixed with 1 L of isopropyl alcohol to obtain a flocculated solid. The flocculated solid was isolated by centrifugation to obtain a gelatinous slab, which was then rinsed with 250 mL of isopropyl alcohol, re-centrifuged, and separated from the isopropyl alcohol. The gelatinous slab was then dried at 60° C. overnight to remove excess solvent. After cooling, an off-white solid PVA-PCL graft copolymer was obtained and then ground into a fine powder.

40.0 g of the PVA-PCL graft copolymer was dissolved in 250 mL of anhydrous dimethylformamide (DMF) and heated at 40° C. while stirring for three hours. Once the copolymer was completely dissolved, 2.76 mL of triethylamine (5 wt % relative to PVA-PCL graft copolymer) was added to the mixture, followed by dropwise addition of 1.79 mL of acryloyl chloride (5 wt % relative to PVA-PCL graft copolymer). The reaction mixture was stirred overnight at 40° C. away from light. After stirring overnight and cooling, the reaction contents were mixed with 2 L of isopropyl alcohol (2×1 L portions) to obtain a flocculated solid. The solid was isolated by centrifugation to obtain a gelatinous slab, which was then rinsed with 500 mL of isopropyl alcohol, re-centrifuged, and separated from the isopropyl alcohol. Following the alcohol wash, 32.0 g (32.0 wt % solids) of acrylated PVA-PCL graft copolymer was obtained.

One-pot synthesis of an acrylated PVA-PCL graft copolymer (representative experimental sample). 160 g of PVA (3.6 mol) was slowly added to 400 mL of N-methyl-2-pyrrolidone previously heated to 100° C. and then stirred for two hours, during which time the reaction mixture became increasingly viscous as the PVA fully dissolved. Thereafter, 1.28 mL of tin (II) 2-ethylhexanoate catalyst was added dropwise to the mixture, immediately followed by 200 mL of ε-caprolactone (1.8 mol). The reaction mixture was stirred overnight at 100° C. After overnight stirring, the reaction mixture was clear and yellow/amber in color. The reaction mixture was cooled to 80° C., and 6.6 mL of triethylamine (47 mmol) was added to the reaction mixture without purifying or isolating the reaction product, followed by dropwise addition of 4.31 mL of acryloyl chloride (53 mmol). Solid particles formed during addition of the acryloyl chloride. The reaction mixture was then stirred for four hours at 80° C. After stirring for four hours, the reaction contents were combined with 8 L (4×2 L portions) of isopropyl alcohol to obtain a flocculated solid. The solid was isolated by centrifugation to obtain a gelatinous mass in each centrifuge tube. The individual gelatinous masses were pooled and then rinsed with 500 mL of isopropyl alcohol, re-centrifuged, and separated from the isopropyl alcohol. Following the alcohol wash, 161.16 g (46.78 wt % solids) of acrylated PVA-PCL graft copolymer was obtained.

Characterization. The comparative and experimental acrylated PVA-PCL graft copolymers were characterized by ¹H-NMR spectroscopy using end-group analysis to determine the degree of polymerization and molar ratios of PVA to PCL of the two copolymers. The degree of polymerization was determined by measuring the integrated amount of methylene groups adjacent to the singly-bonded ester oxygen (4.1 ppm) relative to the amount the terminal methylene groups of the polyester graft (4.0 ppm). The molar ratio of PVA:PCL was determined by integrating the amount of residual acetate groups on the PVA, dividing by the number of hydrogen atoms per acetate group (i.e., 3) and multiplying by the fraction of acetate groups remaining in the PVA (i.e., 0.3), and dividing the result by the integrated amount of PCL. The integrated amount above corresponds to a weighted, relative molar amount of PVA in the graft copolymer. The integrated amount of PCL in the graft copolymer was determined by measuring the integrated amount of methylene groups adjacent to the singly-bonded ester oxygen of the polyester graft or the integrated amount of terminal methylene groups of the polyester graft and dividing by the number of hydrogen atoms per methylene group (i.e., 2) to obtain the weighted, relative molar amount of PCL. Thus, the molar ratio of PVA:PCL represents the quotient of the weighted, relative molar amount of PVA to the weighted, relative molar amount of PCL in the copolymer. The degree of polymerization and PVA:PCL molar ratio for various runs of the one-pot and two-pot syntheses under the above conditions are summarized in Table 1 below. On the whole, the one-pot syntheses tended to afford slightly lower degree of polymerization values and higher PVA:PCL molar ratios, which may arise simply from the lower molar ratio of caprolactone used in the experimental reactions (2:1 molar ratio of PVA:caprolactone versus a 1:1 molar ratio of PVA:caprolactone in the comparative reactions). In addition, the spread of values for the one-pot syntheses tended to be somewhat less.

TABLE 1

| | Degree of | PVA:PCL |
|---|---|---|
| Sample Type | Polymerization | Molar Ratio |
| Two-Pot (Comparative, Run 1) | 15.1 | 3.52:1 |
| Two-Pot (Comparative, Run 2) | 6.75 | 6.33:1 |
| Two-Pot (Comparative, Run 3) | 5.69 | 3.58:1 |
| One-Pot (Experimental, Run 1) | 1.67 | 20.7:1 |
| One-Pot (Experimental, Run 2) | 4.0 | 12.6:1 |
| One-Pot (Experimental, Run 3) | 3.6 | 13.2:1 |

Preparation of a gel polymer electrolyte. 10 g of experimental acrylated PVA-PCL graft copolymer was added to 12.8 g of an electrolyte solution (2.89 M ZnCl₂/0.89 M NH₄Cl in water). The mixture was placed on a roll-mixer away from light for one hour to dissolve the acrylated copolymer in the electrolyte solution. After the acrylated copolymer was dissolved, 16 mg of lithium phenyl-2,4,6-trimethylbenzoylphosphinate (LAP) photoinitiator was added, and residual isopropyl alcohol was removed by rotary evaporation. A drop of the mixture was spread onto a glass microscope slide and cured under a 395 nm 13 W LED lamp at a 5 inch height for one second to obtain a firm gel polymer electrolyte film.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

The invention claimed is:

1. A method comprising:
forming a polyvinyl alcohol (PVA)-polyester graft copolymer in a solvent; and
without isolating the PVA-polyester graft copolymer or separating the PVA-polyester graft copolymer from the solvent, reacting the PVA-polyester graft copolymer with an acrylating agent, optionally in the presence of a base, to form an acrylated PVA-polyester graft copolymer.

2. The method of claim 1, further comprising:
isolating the acrylated PVA-polyester graft copolymer from the solvent.

3. The method of claim 1, wherein the solvent comprises an aprotic solvent.

4. The method of claim 1, wherein the solvent comprises N-methyl-2-pyrrolidone, dimethylformamide, or any combination thereof.

5. The method of claim 1, wherein forming the PVA-polyester graft copolymer comprises:
reacting PVA with a cyclic ester in a reaction mixture comprising the solvent and a catalyst effective to promote ring-opening polymerization of the cyclic ester to form the PVA-polyester graft copolymer.

6. The method of claim 5, wherein the cyclic ester comprises ε-caprolactone.

7. The method of claim 5, wherein the catalyst comprises a tin (II) catalyst.

8. The method of claim 5, wherein the catalyst comprises a tin (II) carboxylate.

9. The method of claim 5, wherein the reaction mixture is heated while forming the PVA-polyester graft copolymer.

10. The method of claim 9, wherein the reaction mixture is heated at about 80° C. to about 120° C. while forming the PVA-polyester graft copolymer.

11. The method of claim 1, wherein heating takes place while forming the acrylated PVA-polyester graft copolymer.

12. The method of claim 11, wherein the heating occurs at about 60° C. to about 100° C. while forming the acrylated PVA-polyester graft copolymer.

13. The method of claim 1, wherein the base is present and comprises a tertiary amine.

14. The method of claim 1, wherein the acrylating agent comprises acryloyl chloride.

15. The method of claim 1, wherein the acrylated PVA-polyester graft copolymer has a molar ratio of PVA to polyester of about 1:10 to about 25:1.

16. The method of claim 1, wherein the acrylated PVA-polyester graft copolymer has a polyester degree of polymerization of about 2 to about 15.

17. The method of claim 1, further comprising:
isolating the acrylated PVA-polyester graft copolymer from the solvent;
after isolating the acrylated PVA-polyester graft copolymer, combining the acrylated PVA-polyester graft copolymer with an electrolyte solution to form a gel polymer electrolyte; and
irradiating the acrylated PVA-polyester graft copolymer with a source of electromagnetic radiation suitable to photopolymerize acrylate groups and in the presence of a photoinitiator to cure the gel polymer electrolyte by crosslinking the acrylated PVA-polyester graft copolymer.

18. A method comprising:
reacting polyvinyl alcohol (PVA) with ε-caprolactone in a reaction mixture comprising an aprotic solvent and a catalyst effective to promote ring-opening polymerization of the ε-caprolactone, thereby forming a PVA-polycaprolactone (PCL) graft copolymer;
wherein the catalyst comprises a tin (II) carboxylate;
without isolating the PVA-PCL graft copolymer or separating the PVA-PCL graft copolymer from the aprotic solvent, reacting the PVA-PCL graft copolymer with acryloyl chloride in the presence of a tertiary amine to form an acrylated PVA-PCL graft copolymer; and
isolating the acrylated PVA-PCL graft copolymer from the aprotic solvent.

19. The method of claim 18, wherein the aprotic solvent comprises N-methyl-2-pyrrolidone, dimethylformamide, or any combination thereof.

20. The method of claim 18, wherein the acrylated PVA-PCL graft copolymer is isolated from the aprotic solvent by precipitation with an alcohol.
